(19) United States
(12) Patent Application Publication
(10) Pub. No.: US 2024/0110438 A1
(43) Pub. Date: Apr. 4, 2024

(54) SOLAR CONTROL INTERLAYER FOR LAMINATES

(71) Applicant: DelStar Technologies, Inc., Alpharetta, GA (US)

(72) Inventors: Nandan Ukidwe, Suffield, CT (US); James Kidwell, Maple Grove, MN (US); Dave Collette, South Hadley, MA (US)

(21) Appl. No.: 18/478,462

(22) Filed: Sep. 29, 2023

Related U.S. Application Data
(60) Provisional application No. 63/412,102, filed on Sep. 30, 2022.

(51) Int. Cl. E06B 9/24; B32B 27/30; B32B 27/40; B32B 37/12

(52) U.S. Cl. CPC E06B 9/24; B32B 27/306; B32B 27/40; B32B 37/1207; E06B 2009/2464; E06B 2009/2476; G02B 27/0101

(57) ABSTRACT

A functional interlayer for incorporation into laminated structures is provided. The functional interlayer may provide solar control properties to the laminated structure. The laminated structure may be part of a window unit.

### CROSS-REFERENCE TO RELATED APPLICATIONS

This application claims the benefit of U.S. Provisional Application No. 63/412,102 filed on Sep. 30, 2022, the complete disclosure of which is incorporated herein by reference for all purposes.

### TECHNICAL FIELD

This description generally relates to laminates having functional properties such as solar control properties, functional interlayers providing such solar control properties for incorporation into the laminates, and various structures including window units formed from such laminates with solar control interlayers.

### BACKGROUND

Solar control films are used in windows for vehicles and dwellings to improve energy efficiency. In residential or commercial buildings, these solar control films help control the heat gain through the window from sunlight. This helps reduce the load on heating, ventilation, and cooling systems, which improves energy efficiency and reduces utility costs. In automotive or other vehicles, fuel efficiency is improved by reducing the heat gain though windows and sunlight. Solar control layers remove energy from sunlight while allowing visible light to pass through. Some solar control films remove energy from the infrared and/or near infrared range.

Laminated Glazing Units (LGUs) are laminated assemblies that include one or more interlayers interposed between transparent rigid plies. The rigid plies can be glass or any other well-known substitute such as polycarbonates, acrylic resins, polyesters, and rigid transparent polyurethanes. The interlayer, which bonds adjacent rigid plies together to form a unified laminated assembly, may be a thermoplastic material such as polyvinyl formal, polyvinyl butyral, polyvinyl iso-butyral, silicone or ethylene vinyl acetate (EVA).

These laminates or LGU's can include glass and/or polymeric panes or layers that provide structural strength, impact resistance, hurricane resistance, and bullet resistance. The laminates can also include sound dampening acoustic barriers to reduce the intrusion of noise in an automobile or building. Preferably, the laminates have a high degree of optical clarity, low haze, long term thermal stability, and long term weatherability.

Some of the known solar control films have a transparent flexible polymer substrate with a thin layer of reflective metal deposited on it by vapor or sputter deposition. The flexible polymer substrate is prone to chemical attack, mechanical abrasion, and lacks structural support. The film is typically formed on a polyethylene terephthalate (PET) or polyethylene naphthalate (PEN) substrate. The film is incorporated in a multilayer laminate having additional layers to provide hard protective layers, abrasion-resistant coatings, impact resistance, and other features as desired. The film may have a pressure-sensitive adhesive (PSA) coating to adhere to the glass pane, and a release liner that is later stripped away and discarded before use.

Interlayers used in laminates must have good adhesion to the substrate as well as the rigid outer panes of the window. In addition, the interlayer must have optical clarity, durability, and suitable thermal and mechanical properties. The interlayers should have structural strength and load bearing capability in the event the rigid outer panes are broken due to crime, natural disaster, weather, etc. Interlayers should adjust to different coefficients of expansion in the different layers of the laminates, have excellent optical clarity and stability, in addition to impact resistance and good adhesion properties.

There is a need for improved solar control interlayers that address the aforementioned concerns, and more specifically, interlayers having other functional layers that reduce the need for additional layers as carriers or release liners, that provide structural support, and/or that eliminate steps in forming laminates and/or subcomponents for window units.

### SUMMARY

Described herein is a functional interlayer for incorporation into laminated structures which addresses the aforementioned concerns. The functional interlayer may provide solar control properties to the laminated structure. The laminated structure may be part of a window unit.

In accordance with one aspect, an interlayer subcomponent is provided. The interlayer subcomponent may comprise a carrier layer and at least one thermoplastic polyurethane layer on a side thereof. The at least one thermoplastic polyurethane layer may have adhesive properties when heated. The carrier layer may be a solar control layer. The carrier layer can be an electrochromic assembly, an infrared absorbing layer, or an infrared reflective layer.

The thermoplastic polyurethane may be an optical interlayer formed by extrusion. In some embodiments, a first thermoplastic polyurethane layer is disposed on a first side of the carrier layer, and a second thermoplastic polyurethane layer is disposed on a second side of the carrier layer, the second side being opposite the first side. The first thermoplastic polyurethane layer and the second thermoplastic polyurethane layer may have adhesive properties when heated. The first thermoplastic polyurethane layer and the second thermoplastic polyurethane layer may have the same thickness. The first thermoplastic polyurethane layer and the second thermoplastic polyurethane layer may have different thicknesses.

In certain embodiments, the first thermoplastic polyurethane layer, the second thermoplastic polyurethane layer, or both thermoplastic polyurethane layers can be wedge-shaped. Accordingly, the subcomponent may form part of a Head-Up-Display (HUD) window unit.

In some embodiments, a first thermoplastic polyurethane layer can be disposed on a first side of the carrier layer, and a second layer disposed on a second side opposite the first side. The second layer can be selected from the group consisting of polyvinyl butyral, polymethyl methacrylate, ethylene vinyl acetate and polycarbonate. A second thermoplastic polyurethane layer can be disposed on the second layer.

In some embodiments, a first thermoplastic polyurethane layer is disposed on a first side of the carrier layer, and a layer disposed on a second side of the carrier layer that provides acoustic damping. In some embodiments, a first thermoplastic polyurethane layer is disposed on a first side of the carrier layer, and a layer is disposed on a second side of the carrier layer that provides impact resistance.

In some embodiments, a first thermoplastic polyurethane layer can be disposed on a second side of the carrier layer, and a photovoltaic assembly on a first side of the carrier layer. In some embodiments, the first side can be the outward facing side of a window unit. The photovoltaic assembly can comprise a polymeric layer having quantum dots. In some embodiments, the photovoltaic cells can be arranged along edges of the carrier layer. In some embodiments, the photovoltaic cells can be disposed on one or more areas of the layer that, when in a window unit of a building, is not relied upon for transparency.

In some embodiments, a first thermoplastic polyurethane layer can be disposed on a first side of the carrier layer, and an electrochromic assembly can be disposed on a second side of the carrier layer. The electrochromic assembly can comprise a transparent electrode on the second side of the carrier layer, a transparent ion-conductive polymer electrolyte film, and a second transparent electrode to complete the cell. An electrochromic coating can be deposited on either of the two transparent electrodes.

In some embodiments, a first thermoplastic polyurethane layer is disposed on a first side of the carrier layer, and a layer of polyvinyl butyral can be disposed on a second side of the carrier layer. In some embodiments, a first thermoplastic polyurethane layer is disposed on a first side of the carrier layer, and a layer of poly(ethylene co-vinyl acetate) can be disposed on a second side of the carrier layer.

In accordance with another aspect, a window unit for a vehicle or building can have an interlayer subcomponent comprising a carrier layer and at least one thermoplastic polyurethane layer on a side thereof, the at least one thermoplastic polyurethane layer having adhesive properties when heated, the carrier layer being a solar control layer, the interlayer subcomponent being disposed between a first rigid sheet and a second rigid sheet.

In some embodiments, at least one of the first rigid sheet and second rigid sheet is a layer of glass. In some embodiments, at least one of the first rigid sheet and second rigid sheet is a layer of polymer.

The window unit can further comprise electromagnetic shielding, a low emissivity layer, an electrochromic assembly, and/or a photovoltaic assembly.

In accordance with a further aspect, a method of forming an interlayer subcomponent can be provided. The method may comprise providing a carrier layer and extruding a thermoplastic polyurethane layer on a side of the carrier layer, the thermoplastic polyurethane layer having adhesive properties when heated, the carrier layer being a solar control layer.

The solar control layer can be selected from an electrochromic assembly, an infrared reflecting layer, and an infrared absorbing layer.

In some embodiments, a first thermoplastic polyurethane layer can be extruded on a first side of the carrier layer, and a second thermoplastic polyurethane layer extruded on a second side of the carrier layer, the first side being opposite the second side.

The first thermoplastic polyurethane layer can be extruded onto the first surface of the carrier layer in a first pass and then the second thermoplastic polyurethane layer can be extruded onto the second surface of the carrier layer in a second pass. The first pass and the second pass can be performed by the same extruder.

In some embodiments, the method can further comprise gathering the interlayer subcomponent into a roll.

In some embodiments, a first thermoplastic polyurethane layer can be extruded on a first side of the carrier layer, and a second layer extruded on a second side of the carrier layer, the first side being opposite the second side, the second layer being selected from polyvinyl butyral, polymethyl methacrylate, poly(ethylene-co-acrylic acid) alkali metal salts of poly(ethylene-co-acrylic acid), and poly(ethylene-co-vinyl acetate).

The method can further comprise laminating the interlayer subcomponent with a first rigid sheet and a second rigid sheet, the interlayer subcomponent being disposed between the first rigid sheet and the second rigid sheet.

In some embodiments, at least one of the first rigid sheet and second rigid sheet can be a pane of glass. In embodiments, at least one of the first rigid sheet and second rigid sheet can be a rigid sheet of polymer.

In some embodiments, the first thermoplastic polyurethane layer and the second thermoplastic polyurethane layer can be extruded simultaneously.

It is to be understood that both the foregoing general description and the following detailed description are exemplary and explanatory only and are not restrictive of the disclosure. Additional features of the disclosure will be set forth in part in the description which follows or may be learned by practice of the disclosure.

### BRIEF DESCRIPTION OF THE DRAWINGS

The accompanying drawings, which are incorporated in and constitute a part of this specification, illustrate several embodiments and together with the description serve to explain certain principles.

FIG. 1 is a perspective view of a solar control interlayer subcomponent according to an exemplary embodiment;

FIG. 2 is a cross-sectional view of the interlayer subcomponent of FIG. 1;

FIG. 3 is a cross-sectional view of a laminate for a window unit having an interlayer subcomponent according to an exemplary embodiment;

FIG. 4 is a cross-sectional view of an interlayer subcomponent according to an exemplary embodiment;

FIG. 5 is a schematic view of an exemplary embodiment of a system for applying a coating onto a first side of a solar control layer;

FIG. 6 is a schematic view of an exemplary embodiment of a system for applying a coating onto a second side of a solar control layer; and

FIG. 7 is a perspective view of an exemplary embodiment of a window unit.

### DETAILED DESCRIPTION

This description and the accompanying drawings illustrate exemplary embodiments and should not be taken as limiting, with the claims defining the scope of the present disclosure, including equivalents. Various mechanical, compositional, structural, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Described herein is an interlayer subcomponent, for lamination with further layers, to form a laminate or laminated structure such as a Laminated Glazing Unit (LGU). The interlayer subcomponent may have a carrier layer, with one or more polymeric layers having adhesive properties when heated. In some embodiments, the carrier layer can be a solar control layer, including a variable transmission solar control layer, such as an electrochromic assembly, or a fixed transmission solar control layer, such as an infrared absorbing or infrared reflecting layer. The interlayer subcomponent can include low emissivity layers, photovoltaic assemblies having, for example, quantum dots, organic photovoltaic cells, or other solar concentrators such as luminescent solar concentrators (LSCs), electromagnetic shield layers, or other functional layers. The interlayer subcomponent can have a polymeric layer on each of two opposing sides, the polymeric layer having adhesive properties when heated, so that the subcomponent is ready for lamination with other layers. The interlayer subcomponent can be provided on a roll, for lamination with other layers, the adhesive being part of the interlayer subcomponent, and the functional solar control layer being the carrier; no additional carrier is required.

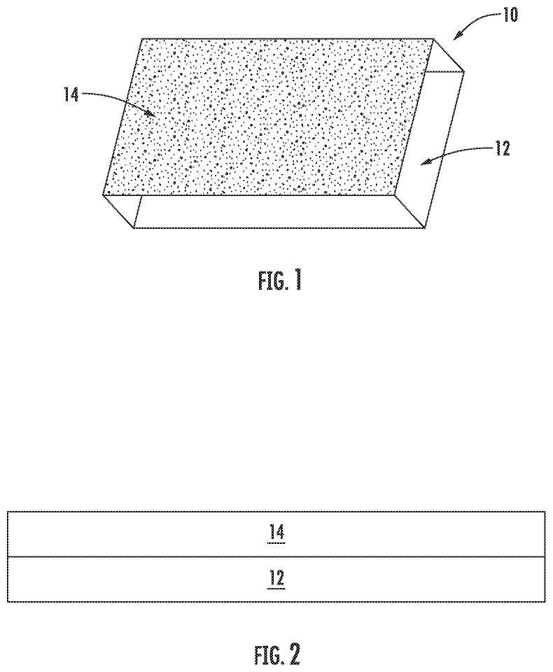

In some embodiments, the interlayer subcomponent can have functional properties such as solar control properties. An exemplary embodiment of such an interlayer subcomponent with solar control properties is shown in FIGS. 1 and 2. The interlayer subcomponent 10 can have a solar control layer 12 and at least one polymeric layer 14 on a side thereof. The polymeric layer 14 can be a thermoplastic polyurethane (TPU) which, when heated, can have adhesive properties. Other suitable polymer materials for polymeric layer 14 can include, for example, polyvinyl formal, polyvinyl butyral (PVB), polyvinyl iso-butyral, silicone, and ethylene vinyl acetate (EVA). Examples of solar control layers are discussed below.

In some embodiments, the interlayer subcomponent 10 can be laminated with layers of glass, or optically clear rigid polymeric sheets such as, for example, polycarbonate, in an autoclave to form a window unit. Other rigid polymeric materials can be used, such as for example, acrylics, polyacrylate, polymethyl methacrylate, cellulose acetate, etc. In some embodiments, combinations of glass and polymeric sheets can be used. It is contemplated that non-autoclave processes may also be employed.

In some embodiments, the polymeric layer 14 of TPU may be an optical interlayer formed by extrusion. Although shown in FIG. 1 as textured, this TPU layer 14 may be substantially transparent and suitable for use in a laminate for a window unit. The optional addition of polycarbonate in the TPU layer 14 can provide bullet and impact resistance, if so desired. The TPU layer 14 can have a thickness of, for example, between about 15 thousandths of an inch and about 75 thousandths of an inch. In some embodiments, the polymeric layer 14 can be formed using calendaring, solution casting, injection molding, and other suitable methods.

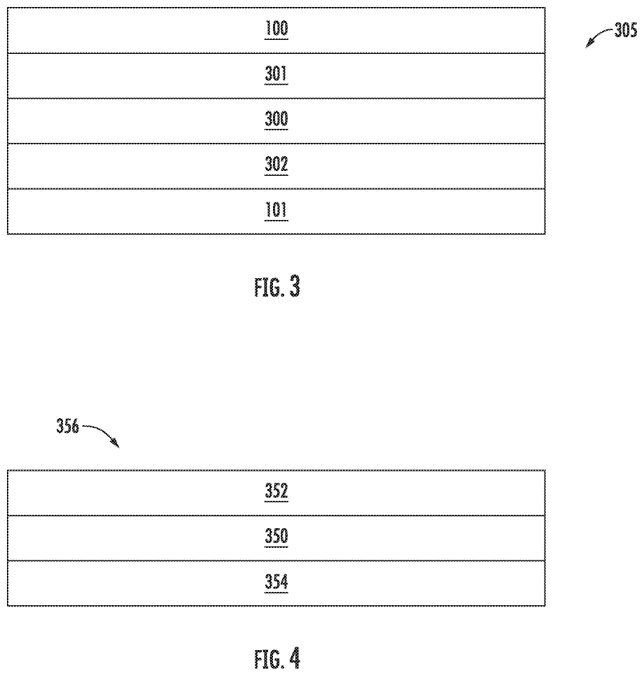

The solar control film 12 may be configured to act itself as a carrier, and thereby avoid the need to use an additional carrier such as a polyethylene terephthalate (PET) carrier or other carrier that is later stripped away and discarded prior to use. In an exemplary embodiment shown in FIG. 3, a TPU interlayer 301 is formed on a first side of a solar control layer 300 and a TPU interlayer 302 is formed on a second side of the solar control layer 300. The TPU layers 301 and 302 may be formed in a two-pass process, which will be explained further below. The interlayer subcomponent can be gathered and provided in a roll. In some embodiments, rigid outer layers 100 and 101 may be laminated with the interlayer subcomponent to provide a laminate 305 for a window unit. Other layers can be added to provide desired functional properties, such as for example, photovoltaic features, electrochromic features, impact resistance, sound dampening, structural strength, and electromagnetic shielding, etc. The layers 100 and 101 can be any of the glass materials mentioned herein, rigid optically clear polymeric sheets, or combinations thereof

In certain embodiments, the first thermoplastic polyurethane layer 301, the second thermoplastic polyurethane layer 302, or both thermoplastic polyurethane layers 301, 302 can be wedge-shaped. Accordingly, the subcomponent may form part of a Head-Up-Display (HUD) window unit.

In some embodiments, the interlayer subcomponent can include electromagnetic shielding and/or conductive properties such as nanowires, sputtered electrodes, etc., that are not visible. Low emissivity layers, transparent conductive films, carbon nanotube transparent electrodes, and other features can be included as part of the interlayer subcomponent. The interlayer subcomponent can include photovoltaic assemblies, electrochromic assemblies, acoustic dampening layers, impact resisting layers, etc. In certain embodiments, one or more such functional layers are provided as the interlayer subcomponent, with polymeric layers on each of two opposing sides of the interlayer subcomponent having adhesive properties when heated.

The interlayer subcomponent can include electromagnetic interference (EMI) shielding, to protect a wireless network or other system in a vehicle or building from electromagnetic interference. EMI shielding layers can include several layers of metal that allow substantial transmission of visible light and may be provided on a polymer substrate such as PET or PEN. For example, alternating layers of dielectric or metal oxide and metal can be formed as a stack and combined with other layers in an interlayer subcomponent or provided in a laminate. The dielectric or metal oxide can include, for example, In₂ O₃, Ti O₂, Nb₂ O₅, Ta₂ O₅, Sn O₂, Zn O or indium tin oxide (ITO). The metal can be, for example, silver, gold, copper, aluminum. In some embodiments, the subcomponent can include a stack of layers of ITO and silver applied by sputter deposition or vapor deposition.

A hard coat may be combined with the interlayer subcomponent disclosed herein. For example, a hard coat can be formed from epoxy, resin, etc. For example, the hard coat can be a cured layer of resin such as, for example, curable particles of silica. For example, UV cured materials may be used.

An exemplary embodiment of a process of forming an interlayer subcomponent can include providing a solar control film or other functional carrier layer and extruding a layer of TPU on the carrier. The solar control film can be selected from an electrochromic assembly, an infrared absorbing layer, infrared reflecting layer, a low emissivity (“low-e”), or other layers. In some embodiments, another TPU layer may be formed on a side of the carrier opposite the first layer of TPU. In certain embodiments, an adhesive layer of PVB or EVA can be formed on the side of the carrier opposite the first layer of TPU. The one or more layers of TPU, PVB, and/or EVA have adhesive properties when heated, making the interlayer subcomponent ready for lamination with other layers. The solar control interlayer subcomponent can be provided on a roll and laminated into a larger assembly for a window unit, the adhesive being provided on the solar control layer as a carrier; no other carrier is required.

In certain embodiments, the solar control layer 300 can be a multilayer stack having electrochromic properties. Electrochromic assemblies can include an electrochromic material having a transparent electrode formed on each opposing side. The electrochromic material is sensitive to an applied voltage. For example, transitional metal oxides are used in the electrochromic material. In some embodiments, transparent conductive layers can be disposed on a layer having a tungsten oxide (“WO3”) electrochromic material deposited on a PET substrate. Such electrochromic materials can be deposited by sputtering, chemical vapor deposition, and other methods. The electrochromic solar control layer or film functions by adjusting the total light transmission in the visible and infrared range. In this example, it is a variable transmission solar control film.

In other embodiments, the solar control layer 300 may be an infrared absorbing or infrared reflective layer, which is a fixed transmission solar control layer. Other variable transmission and fixed transmission technologies are contemplated. For example, metal oxide nanoparticles, infrared absorbing nanoparticles such as antimony tin oxide (“ATO”) and ITO, metal boride nanoparticles, and metalized substrate films, such as aluminum or silver deposited by vacuum deposition or sputtering can be used in solar control layers. In some embodiments, solar control layers that remove energy from light in the visible range can be used. In some embodiments, the solar control layers may be substantially transparent and suitable for a laminate for a window unit.

IR reflecting films incorporate metals and/or metal oxides to screen radiation in the non-visible range can be utilized in these subcomponents. In some embodiments, transparent metal layers or a series of metal and dielectric layers can be applied by sputter deposition, vacuum deposition, or other processes. For example, layers of silver or silver gold alloy can be applied. In some embodiments, the dielectric material can be zirconium oxide, tantalum oxide, tungsten oxide, indium tin oxide, etc. In some embodiments, an interlayer subcomponent, or a laminate for a window unit, can include IR reflecting films.

In some embodiments, low-e layers may be employed, and such layers can include a sputter deposited silver layer between dielectric layers such as titanium oxide. In some embodiments, silica or a silica-based material can be applied in a sol-gel process. In some embodiments, an interlayer subcomponent, or a laminate for a window unit, can include a low-e layer.

In certain embodiments, polymeric or TPU interlayers 301, 302 can be formed by extrusion using a flat die. The interlayers 301, 302 may be encapsulating tie layers that adhere to the substrate 300 and the rigid outer layers 100, 101. In some embodiments, the layers 100, 101 may be rigid sheets such as glass panes, for example, and can be any glass material mentioned herein. In some embodiments, the interlayer or interlayers 301, 302 may also have excellent optical clarity, durability, suitable thermal properties to compensate for differences in thermal coefficients of expansion of different layers, and mechanical properties as required for windows in automobiles, other vehicles, and/or buildings. In certain embodiments, the interlayers 301, 302 impart impact resistance to the composite structure. In another example, polycarbonate (PC) can be included in the interlayers 301 and 301 to impart bullet resistance. In some embodiments, the interlayer or interlayers can impart structural strength and load-bearing capability to the composite structure in the case of failure of the outermost glass panes. Examples of such encapsulating tie layers include, but are not limited to, plasticized polyvinyl butyral (PVB), ionomers, thermoplastic polyurethane (TPU) and ethylene vinyl acetate (EVA). In some embodiments, optical TPU interlayers may be used. TPU offers good adhesion properties and also provides impact resisting and bullet resisting properties.

In some embodiments, interlayers 301, 302 can have the same thickness producing a symmetric composite structure. In other embodiments, interlayers 301, 302 can have different thicknesses ranging from between about 3 mil to about 100 mil; in some embodiments from between about 6 mil to about 50 mil; and in some embodiments from between about 10 mil to about 25 mil. As used herein, one mil is one thousandth of an inch.

In some embodiments, interlayers 301, 302 may be two different polymeric materials of equal or unequal thicknesses. For example, at least one of interlayers 301 and 302 may be a PVB interlayer, an acoustic grade interlayer, which may include PVB or polyvinyl acetal (PVA), a solar control interlayer, a structural interlayer, which may include PVB or ionomer, EVA interlayers, optical grade interlayers, solar energy harvesting assemblies, such as photovoltaic assemblies and/or electrochromic assemblies. In certain embodiments, an acoustic interlayer can have a stack of PVB, PET, acrylate, PET, and PVB. In some embodiments, an acrylate acoustic layer is used.

As mentioned above, interlayers 301, 302 may be two different polymeric materials of equal or unequal thicknesses. Examples include but are not limited to: (a) A standard PVB interlayer containing 38 phr triethylene glycol bis(2-ethylhexanoate) plasticizer; (b) an acoustic grade PVB interlayer such as Eastman Saflex Q-series®, Eastman Saflex E-series®, Seksisui S-Lec® and Kuraray Acoustic-grade Tosifol®; (c) solar control PVB, TPU or ionomeric interlayer to reduce heat gain; (d) a structural PVB interlayer containing 20 phr triethylene glycol bis(2-ethylhexanoate) (e) structural ionomer such as Kuraray's SentryGlas Plus; (f) an optical grade EVA interlayer; (g) an energy harvesting interlayer containing inorganic quantum dots or other solar concentrators; and/or (h) an ionically conductive interlayer such as that described in U.S. patent application Ser. No. 17/550,090, entitled “Optically Transparent Polymer Electrolyte Films”, filed Dec. 14, 2021 (“the '090 application”), the entire disclosure of which is hereby incorporated by reference herein. In certain embodiments, the electrolyte disclosed in the '090 application can be used in an electrochromic assembly having transparent electrodes. In certain embodiments, the electrolyte can be an ion conducting interlayer film which is transparent. The ion conducting interlayer film can include a thermoplastic polyurethane (TPU) or a polymethyl methacrylate (PMMA). In some embodiments, the ion conducting interlayer film can include an organic carbonate. In some embodiments, the ion conducting interlayer film can include a dibenzoate or an acrylic monomer. In some embodiments, other types of assemblies can be incorporated, such as photovoltaic assemblies for generating electricity from sunlight.

In some embodiments, the rigid outer layers or substrates 100, 101 may be substantially transparent, abrasion resistant, and/or chemically inert substrates such as soda lime glass, chemically or thermally tempered glass or coated glass products with solar control features such as SUNGATET™ windshields from PPG Industries, Inc. and SOLARSHIELD™ glass from AFG Industries, Inc. In some embodiments, one or more sheets of window glass, plate glass, silicate glass, or sheet glass can be used. In some embodiments, an optically clear rigid polymeric sheet, such as a sheet of polycarbonate, can be used as layer 100, layer 101, or both. In some embodiments, rigid sheets of acrylics, polyacrylate, polymethyl methacrylate may be used.

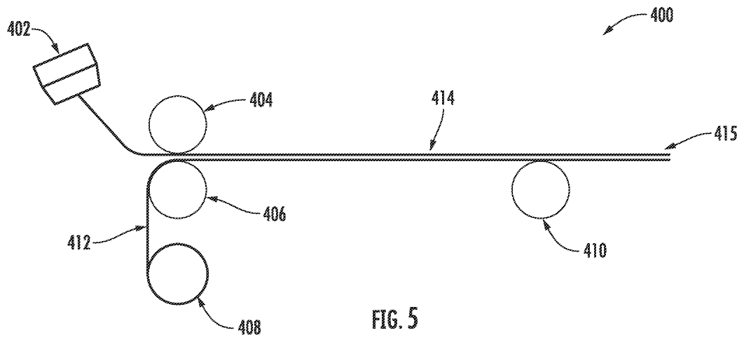

In an exemplary embodiment shown in FIG. 4, the subcomponent 356 can have a solar control layer 350, a layer of TPU 352 formed on a first side of the solar control layer 350, and a layer 354 selected from polyvinyl butyral (PVB), polymethyl methacrylate (PMMA), polycarbonate (PC), or another polymer on a second side opposite the TPU layer 352. The layer 354 on the second side, opposite the layer of TPU 352, can provide acoustic damping or other features. In some embodiments, a second layer of TPU or other adhesive polymer can be formed on the layer 354. The subcomponent 356 having one or more layers of TPU or other adhesive polymer can be provided on a roll. In some embodiments, solar control layer 350 can act a carrier layer, such as by providing or serving as an electrochromic assembly, an infrared absorbing layer, an infrared reflective layer, or low-e layer.

Disclosed herein are exemplary methods of making an interlayer subcomponent having a carrier layer as described. It is possible to lay up individual layers 300, 301, and 302 separately before lamination. However, that would make the lamination process complex, costly and time consuming. In certain embodiments, the interlayers 301, 302 can be extruded onto the solar control layer 300 which could serve as a carrier layer in this context, in separate passes, or simultaneously. In some embodiments, layers 300, 301, and 302 can be combined into a single multilayer subcomponent that can be sold on a roll and cut to size just before lamination.

In certain embodiments, a preexisting solar control layer 300 can be obtained, and used as a carrier onto which at least one adhesive layer is cast. For example, adhesive layers 301 and 302 can be cast onto the preexisting solar control layer 300. Suitable solar control layers that are readily available in the market from various suppliers can be employed. Examples include Eastman Chemical Company's XIR-70, XIR-75, V-Kool and Hüper Optik™ films, ULTRA PERFORMANCE™ 75 film from Bekaert Specialty Films, LLC, S-LEC™ sound and solar film from Sekisui Chemical Co., and 3M's Prestige series window films.

FIG. 5 shows a schematic of an exemplary system for applying an adhesive layer to a side of a solar control layer, according to some embodiments. The system 400 can be configured to perform a first pass in a two-pass process for applying a first layer of adhesive and a second layer of adhesive to a solar control layer in separate passes through the system 400. In some embodiments, the system 400 can be used to apply a single layer of adhesive to the solar control layer. These systems may be used to form an interlayer subcomponent having at least one layer of adhesive on a solar control layer, or other functional layer, for incorporation into a laminate for a window unit.

As shown in FIG. 5, a flat die 402 may be fed by a single or dual screw extruder to extrude a layer of adhesive 414. The solar control layer 412 can be provided on a roll 408. As the solar control layer 412 is unwound, an adhesive layer 414 can be cast, or extruded onto, a side of the solar control layer 412 and passed through a pair of nip rolls 404 and 406. The solar control layer 412 act as the carrier layer, in this instance, without requiring an additional layer of PET or PEN. The resultant interlayer subcomponent 415 can be gathered on a winder 410. In certain embodiments, a melt pump may be located adjacent the die 402, or hot air may be blown toward the adhesive to maintain the desired degree of tackiness in the material. The adhesive may be a thermoplastic polyurethane (TPU) having adhesive properties when heated. Other polymeric coatings can be used, such as polyvinyl butyral (PVB) and ethylene vinyl acetate (EVA).

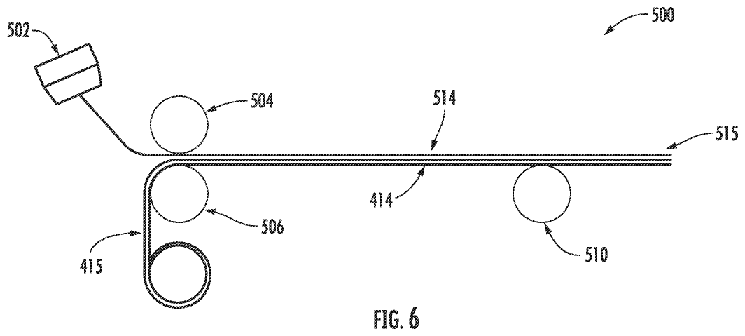

FIG. 6 shows a schematic of an exemplary system 500 for applying an adhesive layer to a side of the solar control layer 412 opposite adhesive 414. The system 500 can be configured similarly to system 400, so that the coated solar control layer 412 can make a second pass through the system to coat the opposite side of the solar control layer 412. In some embodiments, a separate system 500 can be placed adjacent system 400 for applying the second layer of adhesive coating.

As shown in FIG. 6, a flat die 502 can be fed by a single or dual screw extruder to extrude a layer of adhesive 514. The subcomponent 415 can be provided on a roll 508. As the subcomponent 415 is unwound, adhesive layer 514 is cast on a side of the solar control layer 412 opposite adhesive 414 and passed through a pair of nip rolls 504 and 506. The solar control layer 412 can act as the carrier layer, without requiring an additional layer of PET or PEN. The interlayer subcomponent 515 can be gathered on a winder 510 and has a first layer of adhesive on a first side of the solar control layer, and a second layer of adhesive on a second side of the solar control layer.

In some embodiments, a melt pump may be located adjacent the die 502, or hot air may be blown toward the adhesive to maintain the desired degree of tackiness in the material. The adhesive 514 may be a thermoplastic polyurethane (TPU) having adhesive properties when heated. Other polymeric coatings can be used, such as for example, polyvinyl butyral (PVB), and ethylene vinyl acetate (EVA).

In further embodiments, system 500 can be used to coat the solar control layer 412 with PVB, PMMA, PC or other polymer on a side opposite the layer of adhesive 414. In certain embodiments, a layer of TPU or other adhesive can be coated on the assembly opposite the layer 414. In some embodiments, two interlayers can be cast simultaneously using a single sheeting die, or two sheeting dies.

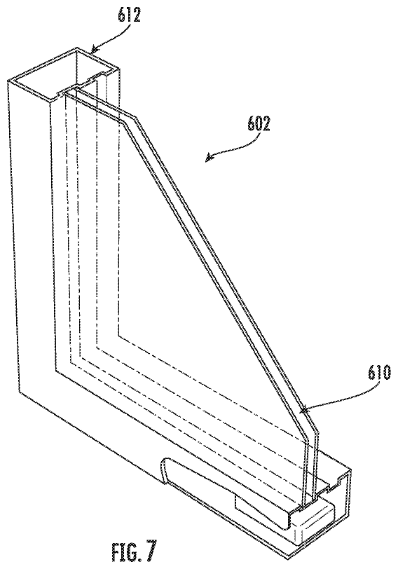

It is contemplated that a window unit 602 may be provided having a solar control interlayer subcomponent 610, as shown in FIG. 7. The interlayer subcomponent 610 may be provided in a window frame 612. In other contemplated embodiments, other structures and assemblies may also be included, such as for example, an acoustic grade layer, which may include PVB or polyvinyl acetal (PVA), a structural layer, which may include PVB or ionomer, solar energy harvesting assemblies, such as photovoltaic assemblies and/or electrochromic assemblies. In certain embodiments, the window unit can be used on a specific side of a building, and can include transparent portions and semi-transparent or opaque portions. For example, transparent portions can include energy harvesting aspects, such as quantum dots that are disposed within the transparent portions, with photovoltaic cells disposed in portions that are not relied on for transparency, such as an opaque portion that does not form part of the window area. In other embodiments, photovoltaic cells can be located at one or more edges of the laminate or window unit.

### EXAMPLES

Exemplary interlayers and laminate samples as described herein were prepared and evaluated.

### Example 1

A trilayer film was formed by disposing a first thermoplastic polyurethane layer on one side of a carrier layer with solar control functionality, and further disposing a second thermoplastic polyurethane layer on the second side of the carrier layer, wherein the second side is opposite the first side. The first and second thermoplastic polyurethane layers were extruded from aliphatic polyether resin sold by BASF as Elastollan® L1275A10 and had a nominal thickness of 0.025 inch or 0.635 mm. The carrier layer with solar control functionality was an architectural window film, C-1, sold by Madico as Solar Grey 35. It transmitted 32.3% of visible light and had a haze of 1.03%. The trilayer film was further encapsulated between two rigid borosilicate glass panes, each with a thickness of 0.125 inch or 3.175 mm, and laminated using a vacuum autoclave at a temperature of 239° F. and pressure of 100 psi. The resultant laminates S-1A and S-1B had a light transmittance and haze of 37.7% and 1.31% on average, respectively.

### Example 2

A trilayer film was formed by disposing a first thermoplastic polyurethane layer on one side of a carrier layer with solar control functionality, and further disposing a second thermoplastic polyurethane layer on the second side of the carrier layer, wherein the second side is opposite the first side. The first and second thermoplastic polyurethane layers were extruded from aliphatic polyether resin sold by BASF as Elastollan® L1275A10 and had a nominal thicknesses of 0.025 inch or 0.635 mm. The carrier layer with solar control functionality was an architectural window film, C-2, sold by Madico as Solar Bronze 35. It transmitted 34.1% of visible light and had a haze of 1.09%. The trilayer film was further encapsulated between two rigid borosilicate glass panes, each with a thickness of 0.125 inch or 3.175 mm, and laminated using a vacuum autoclave at a temperature of 239° F. and pressure of 100 psi. The resultant laminates S-2A and S-2B had a light transmittance and haze of 39.9% and 1.075% on average, respectively.

### Example 3

A trilayer film was formed by disposing a first thermoplastic polyurethane layer on one side of a carrier layer with solar control functionality, and further disposing a second thermoplastic polyurethane layer on the second side of the carrier wherein the second side is opposite the first side. The first and second thermoplastic polyurethane layers were extruded from aliphatic polyether resin sold by BASF as Elastollan® L1275A10 and had a nominal thickness of 0.025 inch or 0.635 mm. The carrier layer with solar control functionality was an architectural window film, C-3, sold by Madico as Optivision® Reflective 5. It transmitted 6.53% of visible light and had a haze of 3.72%. The trilayer film was further encapsulated between two rigid borosilicate glass panes, each with a thickness of 0.125 inch or 3.175 mm, and laminated using a vacuum autoclave at a temperature of 239° F. and pressure of 100 psi. The resultant laminates S-3A and S-3B had a light transmittance and haze of 6.635% and 4.485% on average, respectively.

### Comparative Example 1

Two laminates were constructed by laying up two layers of thermoplastic polyurethane extruded from aliphatic polyether resin sold by BASF as Elastollan® L1275A10. Each layer had a nominal thickness of 0.025 inch or 0.635 mm. The two layers were further encapsulated between two rigid borosilicate glass panes, each with a thickness of 0.125 inch or 3.175 mm, and laminated using a vacuum autoclave at a temperature of 239° F. and pressure of 100 psi. No carrier layer was disposed between these two thermoplastic polyurethane layers. The resultant laminates CS-1A and CS-2A had light transmittance and haze of 93.5% and 0.83% on average, respectively.

As seen from Examples 1-3 and Comparative Example 1 and as summarized in Table 1, disposing thermoplastic polyurethane layers on the first and the second sides of a functional carrier layer, and further laminating the said trilayer between two rigid panes of glass, did not affect light transmission and haze values of the resultant composite too adversely.

TABLE 1
Light transmission and haze values of functional carriers,
Examples 1-3, and Comparative Example 1.

| Sample | | LT | Haze |
|---|---|---|---|
| No. | Sample Description | (%) | (%) |
| C-1 | Solar Grey 35 | 32.30 | 1.03 |
| C-2 | Solar Bronze 35 | 34.10 | 1.09 |
| C-3 | Optivision Reflective 5 | 6.53 | 3.72 |
| S-1A | 0.125″ glass \| 0.025″ TPU | 37.70 | 1.28 |
| S-1B | C-1 \| 0.025″ TPU \|0.125″ | 37.70 | 1.34 |
| | glass | | |
| S-2A | 0.125″ glass \| 0.025″ TPU \| | 40.00 | 1.18 |
| S-2B | C-2 \| 0.025″ TPU \|0.125″ | 39.80 | 0.97 |
| | glass | | |
| S-3A | 0.125″ glass \| 0.025″ TPU | 6.72 | 5.14 |
| S-3B | C-3 \| 0.025″ TPU \|0.125″ | 6.55 | 3.83 |
| | glass | | |
| CS-1A | 0.125″ glass \| 0.025″ TPU \| | 93.50 | 1.04 |
| CS-1B | 0.025″ TPU \|0.125″ glass | 93.50 | 0.62 |

As see in Table 1 above, although an increase in light transmission and haze was observed for all three examples versus their respective functional carrier films, the optical properties still remained acceptable.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

For example, according to one aspect, in a Pt embodiment, an interlayer subcomponent is provided. The interlayer subcomponent may comprise a carrier layer and at least one thermoplastic polyurethane layer on a side thereof, wherein the at least one thermoplastic polyurethane layer has adhesive properties when heated, and the carrier layer is a solar control layer.

A 2^{nd} embodiment is the 1^{st} embodiment of the interlayer subcomponent, wherein the carrier layer is an electrochromic assembly, an infrared absorbing layer, an infrared reflective layer, or a low-e layer.

A 3^{rd} embodiment is any combination of the first 2 embodiments, wherein the thermoplastic polyurethane layer is an optical interlayer formed by extrusion.

A 4^{th} embodiment is any combination of the first 3 embodiments, wherein a first thermoplastic polyurethane layer is disposed on a first side of the carrier layer, and a second thermoplastic polyurethane layer is disposed on a second side of the carrier layer, the second side being opposite the first side, the first thermoplastic polyurethane layer and the second thermoplastic polyurethane layer having adhesive properties when heated.

A 5^{th} embodiment is any combination of the first 4 embodiments, wherein the first thermoplastic polyurethane layer and the second thermoplastic polyurethane layer have the same thickness.

A 6^{th} embodiment is any combination of the first 5 embodiments, wherein the first thermoplastic polyurethane layer and the second thermoplastic polyurethane layer have different thicknesses.

A 7^{th} embodiment is any combination of the first 6 embodiments, wherein the first thermoplastic polyurethane layer, the second thermoplastic polyurethane layer, or both thermoplastic polyurethane layers are wedge-shaped.

An 8^{th} embodiment is any combination of the first 7 embodiments, wherein the subcomponent forms part of a Head-Up-Display (HUD) window unit.

A 9^{th} embodiment is any combination of the first 8 embodiments, wherein a first thermoplastic polyurethane layer is disposed on a first side of the carrier layer, and further comprising a second layer on a second side opposite the first side, the second layer being selected from the group consisting of polyvinyl butyral, polymethyl methacrylate, poly(ethylene-co-acrylic acid), alkali metal salts of poly(ethylene-co-acrylic acid), and poly(ethylene-co-vinyl acetate).

A 10^{th} embodiment is any combination of the first 9 embodiments, wherein a second thermoplastic polyurethane layer is disposed on the second layer.

An 11^{th} embodiment is any combination of the first 10 embodiments, wherein a first thermoplastic polyurethane layer is disposed on a first side of the carrier layer, and further comprising a layer on a second side of the carrier layer that provides acoustic damping.

A 12^{th} embodiment is any combination of the first 11 embodiments, wherein a first thermoplastic polyurethane layer is disposed on a first side of the carrier layer, and further comprising a layer on a second side of the carrier layer that provides impact resistance.

A 13^{th} embodiment is any combination of the first 12 embodiments, wherein a first thermoplastic polyurethane layer is disposed on a second side of the carrier layer, and further comprising a photovoltaic assembly on a first side of the carrier layer.

A 14^{th} embodiment is any combination of the first 13 embodiments, wherein the first side is an outwardly facing side of a window unit.

A 15^{th} embodiment is any combination of the first 14 embodiments, wherein the photovoltaic assembly comprises a polymeric layer having photovoltaic cells.

A 16^{th} embodiment is any combination of the first 15 embodiments, wherein the photovoltaic assembly comprises a polymeric layer having quantum dots.

A 17^{th} embodiment is any combination of the first 16 embodiments, further comprising photovoltaic cells arranged along an edge of the carrier layer.

An 18^{th} embodiment is any combination of the first 17 embodiments, further comprising photovoltaic cells arranged on a surface of the carrier layer not relied on for transparency.

A 19^{th} embodiment is any combination of the first 18 embodiments, wherein a first thermoplastic polyurethane layer is disposed on a first side of the carrier layer, and further comprising an electrochromic assembly on a second side of the carrier layer.

A 20^{th} embodiment is any combination of the first 19 embodiments, wherein the electrochromic assembly comprises a transparent ion-conductive polymer electrolyte film.

A 21^{st} embodiment is any combination of the first 20 embodiments, wherein the electrochromic assembly includes transparent electrodes.

A 22^{nd} embodiment is any combination of the first 21 embodiments, wherein a first thermoplastic polyurethane layer is disposed on a first side of the carrier layer, and further comprising a layer of polyvinyl butyral on a second side of the carrier layer.

A 23^{rd} embodiment is any combination of the first 22 embodiments, wherein a first thermoplastic polyurethane layer is disposed on a first side of the carrier layer, and further comprising a layer of poly(ethylene co-vinyl acetate) on a second side of the carrier layer.

In a second aspect, a 1^{st} embodiment of a window unit for a vehicle or building is provided. The window unit has the interlayer subcomponent according to any combination of the first 23 embodiments described above disposed between a first rigid sheet and a second rigid sheet.

A 2^{nd} embodiment is the 1^{st} embodiment of the window unit, wherein at least one of the first rigid sheet and second rigid sheet comprises glass.

A 3^{rd} embodiment is any combination of the previous 2 embodiments of the window unit, wherein at least one of the first rigid sheet and second rigid sheet comprises a polymer.

A 4^{th} embodiment is any combination of the previous 3 embodiments of the window unit, further comprising electromagnetic shielding.

A 5^{th} embodiment is any combination of the previous 4 embodiments of the window unit, further comprising a low emissivity layer.

A 6^{th} embodiment is any combination of the previous 5 embodiments of the window unit, further comprising an electrochromic assembly.

A 7^{th} embodiment is any combination of the previous 6 embodiments of the window unit, further comprising a photovoltaic assembly.

In a third aspect, a 1^{st} embodiment of a method of forming an interlayer subcomponent is provided. The method comprises providing a carrier layer, the carrier layer being a solar control layer; and extruding a thermoplastic polyurethane layer on a side of the carrier layer, the thermoplastic polyurethane layer having adhesive properties when heated.

A 2^{nd} embodiment is the 1^{st} embodiment of the previous method, wherein the solar control layer is an electrochromic assembly, an infrared reflecting layer, an infrared absorbing layer, or a low-e layer.

A 3^{rd} embodiment is any combination of the previous 2 embodiments of the method, wherein a first thermoplastic polyurethane layer is extruded on a first side of the carrier layer, and further comprising extruding a second thermoplastic polyurethane layer on a second side of the carrier layer, the first side being opposite the second side.

A 4^{th} embodiment is any combination of the previous 3 embodiments of the method, wherein the first thermoplastic polyurethane layer is extruded onto the first surface of the carrier layer in a first pass, and the second thermoplastic polyurethane layer is extruded onto the second surface of the carrier layer in a second pass.

A 5^{th} embodiment is any combination of the previous 4 embodiments of the method, wherein the first pass and the second pass are performed by the same extruder.

A 6^{th} embodiment is any combination of the previous 5 embodiments of the method, wherein the first thermoplastic polyurethane layer and the second thermoplastic polyurethane layer are extruded simultaneously.

A 7^{th} embodiment is any combination of the previous 6 embodiments of the method, further comprising gathering the interlayer subcomponent into a roll.

An 8^{th} embodiment is any combination of the previous 7 embodiments of the method, wherein a first thermoplastic polyurethane layer is extruded on a first side of the carrier layer, and further comprising extruding a second layer on a second side of the carrier layer, the first side being opposite the second side, the second layer being selected from the group consisting of polyvinyl butyral, polymethyl methacrylate, and polycarbonate.

A 9^{th} embodiment is any combination of the previous 10 embodiments of the method, further comprising laminating the interlayer subcomponent with a first rigid sheet and a second rigid sheet, the interlayer subcomponent being disposed between the first rigid sheet and the second rigid sheet.

A 10^{th} embodiment is any combination of the previous 11 embodiments of the method, wherein at least one of the first rigid sheet and second rigid sheet comprises glass.

An 11^{th} embodiment is any combination of the previous 10 embodiments of the method, wherein at least one of the first rigid sheet and second rigid sheet is a rigid sheet of polymer.

What is claimed is:

1. An interlayer subcomponent, comprising:
a carrier layer and at least one thermoplastic polyurethane layer on a side thereof,
wherein the at least one thermoplastic polyurethane layer has adhesive properties when heated, and the carrier layer is a solar control layer.

2. The interlayer subcomponent according to claim 1, wherein the carrier layer is an electrochromic assembly, an infrared absorbing layer, an infrared reflective layer, or a low-e layer.

3. The interlayer subcomponent according to claim 1, wherein the thermoplastic polyurethane layer is an optical interlayer formed by extrusion.

4. The interlayer subcomponent according to claim 1, wherein a first thermoplastic polyurethane layer is disposed on a first side of the carrier layer, and a second thermoplastic polyurethane layer is disposed on a second side of the carrier layer, the second side being opposite the first side, the first thermoplastic polyurethane layer and the second thermoplastic polyurethane layer having adhesive properties when heated.

5. The interlayer subcomponent according to claim 4, wherein the first thermoplastic polyurethane layer and the second thermoplastic polyurethane layer have the same thickness.

6. The interlayer subcomponent according to claim 4, wherein the first thermoplastic polyurethane layer and the second thermoplastic polyurethane layer have different thicknesses.

7. The interlayer subcomponent according to claim 4, wherein the first thermoplastic polyurethane layer, the second thermoplastic polyurethane layer, or both thermoplastic polyurethane layers are wedge-shaped.

8. The interlayer subcomponent according to claim 7, wherein the subcomponent forms part of a Head-Up-Display (HUD) window unit.

9. The interlayer subcomponent according to claim 1, wherein a first thermoplastic polyurethane layer is disposed on a first side of the carrier layer, and further comprising a second layer on a second side opposite the first side, the second layer being selected from the group consisting of polyvinyl butyral, polymethyl methacrylate, poly(ethylene-co-acrylic acid), alkali metal salts of poly(ethylene-co-acrylic acid), and poly(ethylene-co-vinyl acetate).

10. The interlayer subcomponent according to claim 9, wherein a second thermoplastic polyurethane layer is disposed on the second layer.

11. The interlayer subcomponent according to claim 1, wherein a first thermoplastic polyurethane layer is disposed on a first side of the carrier layer, and further comprising a layer on a second side of the carrier layer that provides acoustic damping.

12. The interlayer subcomponent according to claim 1, wherein a first thermoplastic polyurethane layer is disposed on a first side of the carrier layer, and further comprising a layer on a second side of the carrier layer that provides impact resistance.

13. The interlayer subcomponent according to claim 1, wherein a first thermoplastic polyurethane layer is disposed on a second side of the carrier layer, and further comprising a photovoltaic assembly on a first side of the carrier layer.

14. The interlayer subcomponent according to claim 13, wherein the first side is an outwardly facing side of a window unit.

15. The interlayer subcomponent according to claim 13, wherein the photovoltaic assembly comprises a polymeric layer having photovoltaic cells.

16. The interlayer subcomponent according to claim 13, wherein the photovoltaic assembly comprises a polymeric layer having quantum dots.

17. The interlayer subcomponent according to claim 16, further comprising photovoltaic cells arranged along an edge of the carrier layer.

18. The interlayer subcomponent according to claim 16, further comprising photovoltaic cells arranged on a surface of the carrier layer not relied on for transparency.

19. The interlayer subcomponent according to claim 1, wherein a first thermoplastic polyurethane layer is disposed on a first side of the carrier layer, and further comprising an electrochromic assembly on a second side of the carrier layer.

20. The interlayer subcomponent according to claim 19, wherein the electrochromic assembly comprises a transparent ion-conductive polymer electrolyte film.

21. The interlayer subcomponent according to claim 19, wherein the electrochromic assembly includes transparent electrodes.

22. The interlayer subcomponent according to claim 1, wherein a first thermoplastic polyurethane layer is disposed on a first side of the carrier layer, and further comprising a layer of polyvinyl butyral on a second side of the carrier layer.

23. The interlayer subcomponent according to claim 1, wherein a first thermoplastic polyurethane layer is disposed on a first side of the carrier layer, and further comprising a layer of poly(ethylene co-vinyl acetate) on a second side of the carrier layer.
